(19) United States
(12) Patent Application Publication
(10) Pub. No.: US 2010/0300598 A1
(43) Pub. Date: Dec. 2, 2010

(54) Heavy Goods Vehicle Tire

(75) Inventors: Jean Coue, Romagnat (FR); François Barbarin, Chateaugay (FR)

Correspondence Address: COHEN, PONTANI, LIEBERMAN & PAVANE LLP, 551 FIFTH AVENUE, SUITE 1210, NEW YORK, NY, 10176, US

(73) Assignees: Societe De Technologie Michelin, Clermont-Ferrand (FR); Michelin Recherche et Technique S.A., Granges-Paccot (CH)

(21) Appl. No.: 12/679,473

(22) PCT Filed: Sep. 16, 2008
(86) PCT No.: PCT/EP2008/062301

§ 371 Date: Aug. 9, 2010

(30) Foreign Application Priority Data
Sep. 20, 2007 (FR) 0706650
Nov. 20, 2007 (US) 61003747

(51) Int. Cl. B60C 15/06

(52) U.S. Cl. 152/542

(57) ABSTRACT

Heavy goods vehicle tire, in at least one of the beads of which the following three conditions (A) to (C) are met: (A) the angle formed between the straight line L1 connecting: (i) the centre of the circle of the circular arc forming the rim hook and (ii) the radially outermost point of the wrapped-around portion of the carcass ply, and the axial direction, is greater than or equal to 30°, and less than or equal to 60°; (B) the minimum distance D between the outbound portion of the carcass ply, and the free end of the wrapped-around portion of the carcass ply is less than or equal to 50% of the max distance Dₘₐₓ between the outbound portion and the wrapped-around portion of the carcass ply; and (C) the tire further comprises, axially adjacent to the carcass ply, an additional reinforcing ply, in which the angle formed between the straight line L2 connecting (i) the said centre of the circle of the circular arc and (ii) the radially outermost point of the additional reinforcing ply, and the axial direction is greater than or equal to 60° and the angle formed between the straight line L3 connecting (i) the said centre of the circle of the circular arc forming the rim hook and (ii) the radially innermost point of the additional reinforcing ply, and the axial direction is less than or equal to 30°.

### FIELD OF THE INVENTION

The present invention relates to tires for industrial vehicles capable of carrying heavy loads, such as <<heavy goods>> vehicles. It relates more specifically to a design of bead for such tires, improving the endurance thereof.

### BACKGROUND

The <<bead>> of a tire is that part of the tire that provides the mechanical connection between the tire and the wheel to which the tire is fitted, and which transmits driving and braking torque. It generally comprises an annular reinforcing structure (for example a bead wire) which clamps the tire onto the rim of the wheel. The connection between the crown of the tire and the bead is ensured by a carcass reinforcement which is anchored on the annular reinforcing structure, for example by wrapping the reinforcement around the annular reinforcing structure. The space between the carcass reinforcement (or, more specifically, its <<incoming portion>>, that is to say that part of the carcass reinforcement which runs between the crown and the annular reinforcing structure) and that part of the carcass reinforcement which is wrapped around the annular reinforcing structure (and which, hereinafter, will be termed the <<wrapped-around portion >>) is then filled with a stiff rubber mix which is commonly known by the name of <<bead filler >>. The expression <<rubber mix >> designates a rubber compound containing at least an elastomer and a filler.

The bead forms part of regions which are heavily stressed, cyclically, when the tire is rolling while bearing a heavy load. Since the ability of the bead to withstand damage is a decisive factor in the endurance of the tire, the improvement of the endurance of the beads has been the objective of numerous research efforts. It has, in particular, been found that bead damage usually occurs at the free ends of the carcass reinforcement. There are two particular factors contributing to this.

First, the beads of a tire may be exposed to high temperatures, because the beads are situated in the proximity of the brakes which may cause the rim to heat up. The highest temperatures are reached in the middle of the bead filler. If one end of the carcass reinforcement is situated in this region, then separation between this reinforcement and the rubber mix surrounding it may be observed. To overcome this problem, it has been proposed that the end of the carcass reinforcement be kept away from this area by extending its wrapped-around portion radially outwards (i.e. such that the end is farther away from the axis of rotation of the tire).

Second, the deformation of the bead due to the loading of the tire may also lead to heating liable to favour the onset of damage. The most heavily mechanically stressed region lies axially on the outside of the centre of the bead filler. (Of two points on the tire, one is considered to be <<axially on the outside >> of the other when it is further away from the plane which is normal to the axis of rotation of the tire and which lies mid-way between the annular reinforcing structures of each bead.) This problem can be solved by shortening the wrapped-around portion and by reinforcing the bead with an additional reinforcement armature which is positioned axially on the outside of the bead filler. Each additional reinforcement armature comprises at least one cord extending axially on the outside of the wrapped-around portion of the carcass reinforcement.

There are therefore two different approaches to improving the endurance of the bead by keeping the end of the carcass reinforcement away from the regions of greatest thermal and mechanical stress: either the wrapped-around portion is extended, so that the end of the carcass reinforcement lies radially on the outside of these regions (of two points on the tire, one is considered to be <<radially on the outside >> of the other when it is further away from the axis of rotation of the tire), or it is shortened, in which case the end of the carcass reinforcement lies radially on the inside of these regions.

The first approach has the disadvantage that it is necessary to provide a fairly long wrapped-around portion, which also means that the distance between the incoming portion of the carcass reinforcement and the end of the wrapped-around portion is reduced. As a result, when a crack appears in the end of the wrapped-around portion, it will reach the incoming portion before it reaches the exterior surface of the tire. In other words, the defect will not become visible until some time after it has reached the incoming portion.

The second approach, for its part, makes the tire more difficult to manufacture: when the carcass reinforcement is wrapped around the annular reinforcing structure, the wrapping is not as easy to perform with a shorter wrapped-around portion; there is not enough length available to fold the carcass reinforcement. In addition, there is a risk that the carcass reinforcement will be insufficiently anchored and more readily unwrap itself.

It has been proposed to solve this problem by winding the end around the bead wire, making it possible to increase the area of interface between the wrapped-around portion of the carcass reinforcement and the bead filler, while at the same time preventing the end of the carcass reinforcement from lying in an area of high thermomechanical stresses. Documents U.S. Pat. No. 6,736,177, US 2006/0196591, US 2006/0207710 and US 2007/0056673 disclose various embodiments of this approach. The major disadvantage of this technical solution lies in the fact that it significantly complicates the manufacturing process.

### SUMMARY OF THE INVENTION

One object of the present invention is to provide a tire with improved endurance without in any way making the manufacturing process more difficult.

This object is achieved by a heavy goods vehicle tire, intended to be mounted on a rim with inclined seats, known as <<drop>> or <<well-base>> rim, the seats of which are extended by rim hooks which comprise, in radial section, a part in the form of a circular arc, the tire comprising:

a crown;

two beads each comprising an annular reinforcing structure; and

at least one radial carcass reinforcement which extends from one bead to the other and which is anchored in the two beads by being wrapped around the annular reinforcing structure, so as to form, within each bead, an incoming portion and a wrapped-around portion;

the tire being configured in such a way that, when the tire is mounted on the rim and inflated, in at least one of the beads the following three conditions (A) to (C) are met:
(A) an angle α (alpha) formed between:
the straight line L1 connecting:
(i) the centre of the circular arc forming the rim hook and
(ii) the radially outermost point of the wrapped-around portion of the carcass reinforcement, and
the axial direction,
is greater than or equal to a first angle α1 of 30°, and less than or equal to a second angle α2 of 60°, the angle α (alpha) being measured in the clockwise direction starting from the straight line L1;
   (B) the minimum distance D between:
the incoming portion of the carcass reinforcement, and
the free end of the wrapped-around portion of the carcass reinforcement
is less than or equal to 50% of the maximum distance Dₘₐₓ the incoming portion and the wrapped-around portion of the carcass reinforcement, this distance being measured in a direction parallel to L1; and
   (C) the tire further comprises, axially adjacent to the carcass reinforcement, an additional reinforcement armature the reinforcements of which are inclined by an angle of less than 45° with respect to the circumferential direction, and in which a third angle β formed between:
the straight line L2 connecting:
(i) the centre of the circular arc forming the rim hook and
(ii) the radially outermost point of the additional reinforcement armature, and
the axial direction
is greater than or equal to the said second angle α2, and a fourth angle γ formed between:
the straight line L3 connecting:
(i) the centre of the circular arc forming the rim hook and
(ii) the radially innermost point of the additional reinforcement armature, and the axial direction
is less than or equal to the said first angle α1.

It has been found that a tire according to the invention has excellent endurance. This result appears to be due to the fact that the free end of the wrapped-around portion of the carcass reinforcement is in a region of lower thermal and mechanical stresses, without there being any need to reinforce the bead with an additional reinforcement armature positioned axially on the outside of the bead filler (this additional reinforcement armature is sometimes referred to as <<stiffener>>). It should be noted that if such a stiffener was provided, it would in turn be exposed to the high stresses characteristic of this region. The presence of an additional reinforcement armature axially adjacent to the carcass reinforcement judiciously compensates for the absence of a stiffener. The manufacturing difficulties due to a wrapped-around portion that is very short or wound around the annular reinforcing structure, are also avoided.

As a preference, the additional reinforcement armature, axially adjacent to the incoming portion of the carcass reinforcement, is positioned between the incoming portion of the carcass reinforcement and the interior surface of the tire. The <<interior surface of the tire >> is to be understood here to mean the surface of the tire intended to be in contact with the inflating gas. This embodiment has the advantage of avoiding introducing an end of a reinforcement armature into a region of high mechanical deformation and high thermal stress.

According to an alternative embodiment, the additional reinforcement armature, axially adjacent to the incoming portion of the carcass reinforcement, is positioned between the incoming portion of the carcass reinforcement and the exterior surface of the tire. The <<exterior surface of the tire >> is to be understood here to mean the surface of the tire freely accessible when the tire is mounted on the rim and inflated. This alternative embodiment is advantageous in so far as it simplifies the method of manufacture.

According to a preferred embodiment, the minimum distance D is less than 25% of Dₘₐₓ. The advantage of this embodiment lies in the fact that it becomes more difficult for the wrapped-around portion to become unwrapped.

As a preference, the reinforcements of the additional reinforcement armature are inclined by an angle of less than 5° with respect to the circumferential direction. Thus, the reinforcements act like bead wires, thus improving the firmness of the tire.

According to one preferred embodiment, conditions (A) to (C) are met in both beads. A symmetric arrangement such as this simplifies the design of the tire and the method of manufacture.

The additional reinforcement armature may be formed of a plurality of cords positioned on circles concentric with the axis of rotation of the tire, but it is equally possible for the additional reinforcement armature to be formed by arranging one or more cords spiral-wound about the axis of rotation of the tire. The cord or cords may in particular be fractionated, that is to say chopped (this may in particular be done at the time of laying) so that each turn of the spiral comprises a plurality of circular arcs, thus optimizing the movements of material when shaping the tire and making the tire easier to manufacture.

According to an advantageous embodiment, the minimum distance D is greater than 3 mm. Thus, it is possible to avoid having the incoming and wrapped-around portions too closely spaced, as such a spacing would be liable to initiate crack formation.

### BRIEF DESCRIPTION OF THE DRAWINGS

FIG. 1 shows part of a tire of the prior art, mounted on a rim of the <<drop >> or <<well-base >> type, in radial section.

FIG. 2 shows a detail of FIG. 1.

FIG. 3 shows part of a tire according to the invention, in radial section.

FIG. 4 shows an alternative embodiment to that depicted in FIG. 3, with a different position for the additional reinforcement armature.

### DETAILED DESCRIPTION OF THE DRAWINGS

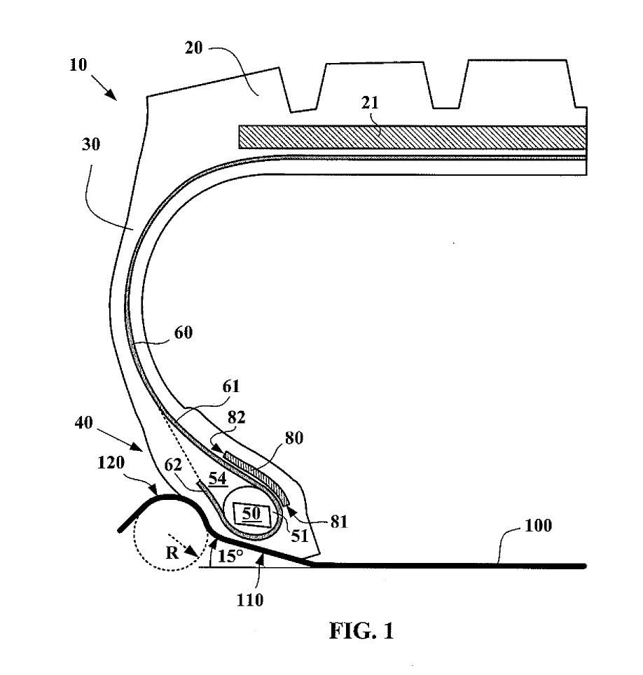

FIG. 1 shows, in radial section, part of a tire 10 according to the prior art, mounted on a rim 100, having seats 110 that are inclined with respect to the axial direction, here by an angle of 15°. The seat 110 is extended axially toward the outside by a rim hook 120 which comprises a part in the form of a circular arc. The radius R of this circular arc is also indicated. The tire 10 comprises a crown 20 with a belt 21, surmounted by a tread. It also comprises two side walls 30 and two beads 40 each of which has an annular reinforcing structure 50, here in the form of a bead wire, surrounded by a <<bead core >> 51 made of rubber mix. The tire 10 also comprises a carcass reinforcement 60 which extends from one bead 40 to the other and which is anchored in each of the two beads 40 by a turn-up. In each bead, it is therefore possible to draw a distinction between two parts of the carcass reinforcement 60: an <<incoming portion >> 61 which corresponds to that part of the carcass reinforcement which connects the bead 40 to the crown 20, and a <<wrapped-around portion >> 62 which anchors the reinforcement onto the annular reinforcing structure 50. In the context of this document, the boundary between the incoming portion 61 and the wrapped-around portion 62 in the bead depicted is considered to consist of the intersection of the carcass reinforcement 60 with a plane (not depicted) perpendicular to the axis of rotation of the tire and passing through the radially innermost point of the carcass reinforcement 60.

The tire 10 also comprises, axially on the inside of the carcass reinforcement 60, a reinforcement armature 80 formed of a plurality of cords positioned on circles concentric with the axis of rotation of the tire and extending between a radially inner end 81, here located more or less level with the radially outermost part of the annular reinforcing structure 50, and a radially outer end 82. The cords can be inclined at an angle of between −45 and +45° with respect to the circumferential direction in order for the object of the invention to be achieved. However, such angle is preferably between −5° and +5° because then the cords of reinforcement armature 80 work like additional bead wires.

The position of the <<bead filler >> 54, formed of at least one rubber mix, is also marked in FIG. 1, where its limit is schematically delineated by a dotted line.

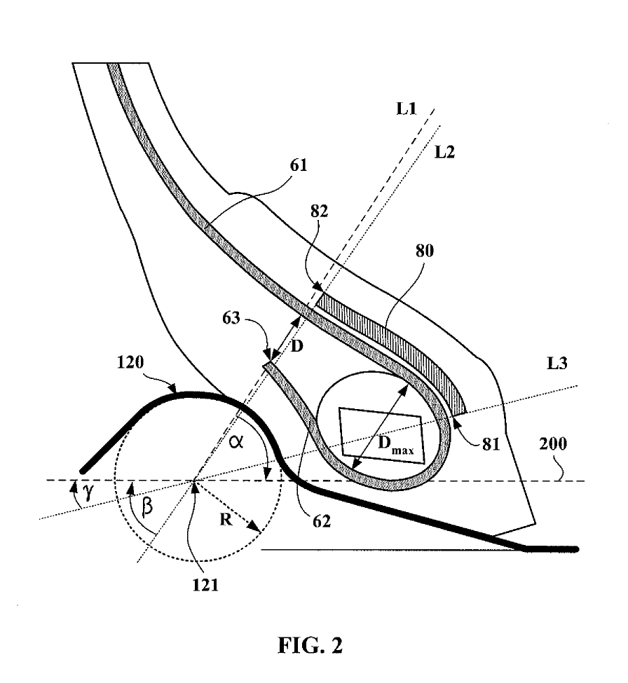

FIG. 2 shows a detail of the tire of FIG. 1 and illustrates several parameters for characterizing the differences between a tire according to the prior art and a tire according to the invention. All these parameters are determined when the tire 10 is mounted on the rim 100 and inflated to its operating pressure.

Reference 121 denotes the centre of the circular arc (radius R) forming the rim hook. Reference denotes the radially outermost point of the wrapped-around portion 62 of the carcass reinforcement 60. The straight line L1 connects the centre 121 to the point 63. It makes an angle α (alpha) with the axial direction 200. In the context of this document, this angle is measured in the clockwise direction starting from the straight line L1. In this instance, the angle α measures 58°.

The minimum distance between the incoming portion 61 of the carcass reinforcement and the free end of the wrapped-around portion 62 is denoted D. The maximum distance between the incoming portion 61 and the wrapped-around portion 62, measured in a direction parallel to L1 is denoted Dₘₐₓ. In the tire depicted, the ratio D/Dₘₐₓ is 60%.

There are two further angles that need still to be defined: let L2 be the straight line connecting the centre 121 of the circular arc forming the rim hook 120 to the radially outermost point 82 of the additional reinforcement armature 80. The angle β (beta) is then the angle formed between this straight line L2 and the axial direction 200. Likewise, if L3 denotes the straight line connecting the centre 121 of the circular arc forming the rim hook 120 to the radially innermost point 81 of the additional reinforcement armature 80, then the angle γ (gamma) is defined as the angle formed between this straight line L3 and the axial direction 200. In both instances, the angle is measured in the clockwise direction starting from the straight line concerned (L2 or L3). In this instance, β (beta) adopts a value close to that of the angle α (alpha), namely 57°, while γ (gamma) measures 14°.

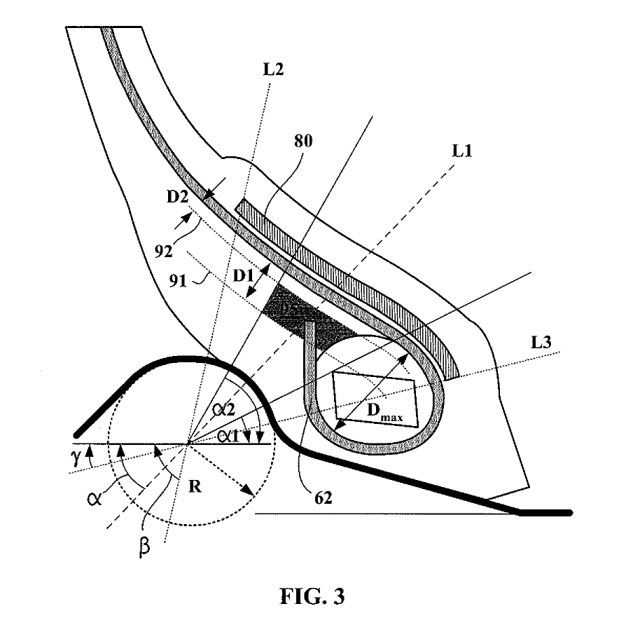

FIG. 3 shows part of a tire according to the invention, in radial section. The crown and the side wall are identical to the corresponding parts of the tire 10 of FIG. 1, only the bead has been altered: the wrapped-around portion 62 is wrapped further around the bead wire.

In a tire according to the invention, the end of the wrapped-around portion 62 is such that the angle α (alpha), defined above, ranges between an angle α1 (alpha 1) of 30° and an angle α2 (alpha 2) of 60°. According to an advantageous embodiment, the angle α (alpha) ranges between an angle α1 (alpha 1) of 40° and an angle α2 (alpha 2) of 50°. In this instance, the angle α (alpha) is 48°. Condition (A) is therefore met.

The minimum distance D is less than a value D1 equivalent to 50% of the distance Dₘₐₓ. All of the points lying at the distance D1 from the carcass reinforcement are outlined by the curve 91. In the tire depicted, the ratio D/Dₘₐₓ is 20%. Thus, condition (B) is also met.

Finally, the tire according to the invention comprises an additional reinforcement armature 80. Unlike the tire of FIG. 1, this additional reinforcement armature 80 extends over a wider area, which is manifested by the fact that the angle β (beta), here 78°, is greater than the angle α2 (alpha 2) and that the angle γ (gamma), here 14°, is less than the angle α1 (alpha 1). Condition (C) is therefore also met.

The tire depicted in FIG. 3 corresponds to a preferred embodiment in as much as the distance D, here 6 mm, is greater than a minimum distance D2 of 3 mm. All of the points lying the minimum distance D2 from the incoming portion 61 of the carcass reinforcement 60 are outlined by the curve 92. The darker area 95 therefore corresponds to the region in which the free end of the wrapped-around portion 62 of the carcass reinforcement may lie such that conditions (A) to (C) are met and the minimum distance D is greater than or equal to D2.

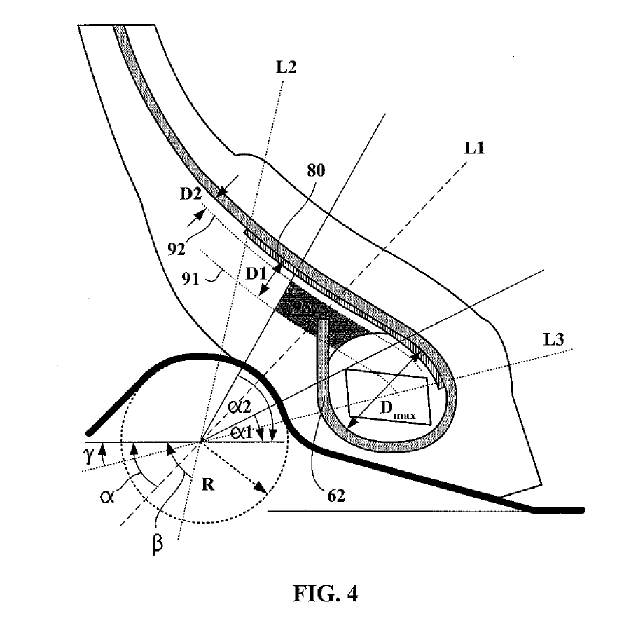

FIG. 4 shows the same view as in FIG. 3. However, the additional reinforcement armature 80 which is axially adjacent to the incoming portion 61 of the carcass reinforcement, is positioned between the incoming portion 61 and the exterior surface of the tire.

Comparative running tests have demonstrated that a tire according to FIG. 3 (of the 295/60 R22.5 size) has longer endurance than a tire according to FIG. 1 (of the same size). This improvement was observed during tests of the <<heated rim >> type in which the resistance to unwrapping of the carcass reinforcement as a function of temperature proved to be greater (20% better) and also <<bead breaking >> tests (which consist in running a tire under severe conditions in order to amplify the flexural deformations and cause breaks to be introduced into the ends of the wrapped-around portion of the carcass reinforcement or any additional reinforcement armatures) in which the improvement in endurance in terms of distance traveled is about 90% (52 000 km as against 27 000 km).

1. A heavy goods vehicle tire, configured to be mounted on a rim with inclined seats, the seats of which are extended by rim hooks which comprise, in radial section, a part in the form of a circular arc, the tire comprising:
a crown;
two beads each comprising an annular reinforcing structure; and
at least one radial carcass reinforcement which extends from one bead to the other and which is anchored in the two beads by being wrapped around the annular reinforcing structure, so as to form, within each bead, an incoming portion and a wrapped-around portion;
the tire being configured in such a way that, when the tire is mounted on the rim and inflated, in at least one of the beads the following three conditions (A) to (C) are met:
(A) an angle α (alpha) formed between:
(a) the straight line L1 connecting:
(i) the center of the circular arc forming the rim hook, and
(ii) the radially outermost point of the wrapped-around portion of the carcass reinforcement; and
(b) the axial direction,
is greater than or equal to a first angle α1 of 30°, and less than or equal to a second angle α2 of 60°, the angle α (alpha) being measured in the clockwise direction starting from the straight line L1;
(B) the minimum distance D between:
(a) the incoming portion of the carcass reinforcement, and
(b) the free end of the wrapped-around portion of the carcass reinforcement is less than or equal to 50% of the maximum distance Dₘₐₓ between the incoming portion and the wrapped-around portion of the carcass reinforcement, this distance being measured in a direction parallel to L1; and
(C) the tire further comprises, axially adjacent to the carcass reinforcement, an additional reinforcement armature the reinforcements of which are inclined by an angle of less than 45° with respect to the circumferential direction, and in which a third angle β formed between:
(a) the straight line L2 connecting:
(i) the centre of the circular arc forming the rim hook, and
(ii) the radially outermost point of the additional reinforcement armature; and
(b) the axial direction
is greater than or equal to said second angle α2, and a fourth angle γ formed between:
(a) the straight line L3 connecting:
(i) the centre of the circular arc forming the rim hook, and
(ii) the radially innermost point of the additional reinforcement armature; and
(b) the axial direction
is less than or equal to the said first angle α1.

2. The tire of claim 1, in which wherein the additional reinforcement armature, axially adjacent to the incoming portion of the carcass reinforcement, is positioned between the incoming portion of the carcass reinforcement and the interior surface of the tire.

3. The tire of claim 1, wherein the additional reinforcement armature axially adjacent to the incoming portion of the carcass reinforcement, is positioned between the incoming portion of the carcass reinforcement and the exterior surface of the tire.

4. The tire of claim 1, wherein the minimum distance D is less than 25% of Dₘₐₓ.

5. The tire of claim 1, wherein the reinforcements of the additional reinforcement armature are inclined by an angle of less than 5° with respect to the circumferential direction.

6. The tire of claim 1, wherein conditions (A) to (C) are met in both beads.

7. The tire of claim 1, wherein the additional reinforcement armature is formed of a plurality of cords positioned on circles concentric with the axis of rotation of the tire.

8. The tire of claim 1, wherein the additional reinforcement armature is formed of one or more cords spiral-wound around the axis of rotation of the tire.

9. The tire of claim 8, wherein the cord or cords are fractionated so that each turn of the spiral comprises a plurality of circular arcs.

10. The tire of claim 1, wherein the minimum distance D is greater than 3 mm.
